(19) United States
(12) Patent Application Publication
(10) Pub. No.: US 2024/0234943 A1
(43) Pub. Date: Jul. 11, 2024

(54) METHOD FOR PREPARING A SOLID ELECTROLYTE

(71) Applicant: RENAULT S.A.S., Boulogne Billancourt (FR)

(72) Inventors: Mohamed CHAKIR, Guyancourt (FR); Mathieu MORCRETTE, Amiens (FR); Xavier RANDREMA, Amiens (FR); Virginie VIALLET, Boves (FR)

(73) Assignee: RENAULT S.A.S., Boulogne Billancourt (FR)

(21) Appl. No.: 18/570,396

(22) PCT Filed: Jun. 13, 2022
(86) PCT No.: PCT/EP2022/065955

§ 371 Date: Dec. 14, 2023

(30) Foreign Application Priority Data
Jun. 15, 2021 (FR) FR2106345

(51) Int. Cl. H01M 50/403; H01M 10/0562; H01M 50/431

(52) U.S. Cl. CPC H01M 50/403; H01M 10/0562; H01M 50/431; H01M 2300/0068

(57) ABSTRACT

A method for preparing a solid electrolyte is described. The method involves mixing a solid electrolyte selected from among sulfides with an agent comprising at least sulfur, adding the mixture obtained to an organic solvent, and then recovering the resulting solid electrolyte. The method may be used to form the solid electrolyte as a separator for a battery cell.

### TECHNICAL FIELD

The present invention relates to the field of all-solid-state batteries. More particularly, the present invention relates to a process for the particular preparation of a solid electrolyte.

The present invention also relates to a process for the preparation of an all-solid-state battery cell.

### PRIOR ART

Conventionally, all-solid-state batteries comprise one or more positive electrodes, one or more negative electrodes, a solid electrolyte forming a separator, an anode current collector and a cathode current collector.

The performance qualities of a battery are dependent on the ion and electron transport properties. In the case of an all-solid-state battery, ion transport at the scale of the electrode takes place through the network formed by the solid electrolyte. In order for such a battery to be in an operating state, this network is percolated, forming ion conduction paths through the entire volume of the electrode, to ensure the transport of the ions to or from all of the active material particles.

All-solid-state batteries use different types of materials as solid electrolytes, for example polymers, such as poly (ethylene oxide) (PEO), and the like, oxides, such as garnet, perovskites, nasicons, and the like, or also sulfides (LGPS, LPS, LPSCL, and the like).

This use remains generally limited to the laboratory scale through the use of very small cells (button cell, small cells with a capacity of less than 2 Ah).

The manufacture of all-solid-state batteries is a major challenge for all the players in this field but many problems remain to be solved before developing this technology on the industrial scale. This is because the players in the field are confronted with various technological obstacles.

The high cost of the materials of the solid electrolyte is in particular one of the issues. This is because particular operating conditions must be observed.

For example, the synthesis of the solid electrolyte materials of the family of the oxides is to be carried out at high temperature. The shaping of the solid electrolytes of the family of the oxides and of the sulfides is difficult.

The ion conductivities of the solid electrolyte materials are moreover generally low.

As regards in particular the solid electrolyte materials of the family of the sulfides, the processing at present involves a “dry” preparation process without a dissolution stage. The use of these solid electrolyte materials via a “dry” process leads to many disadvantages.

Thus, It is difficult to reduce the size of the solid electrolyte particles and consequently to reduce and/or eliminate the porosity in the electrodes obtained.

It is also difficult to shape the solid electrolyte forming the separator, thus implying the impossibility of obtaining thin films with a thickness of the order of 10 to 25 μm, but also the difficulty of obtaining homogeneous electrodes.

Because of these various disadvantages, the electrochemical performance qualities are not satisfactory.

Moreover, the use of solid electrolyte materials of the family of the sulfides in solution has been attempted. Unfortunately, a degradation of the chemical structure and a loss of the ionic conductivity of the solid electrolytes are observed.

There thus exists a need to develop a novel process for the preparation of a solid electrolyte involving the use of a solid electrolyte chosen from sulfides which makes it possible to overcome the abovementioned disadvantages.

It has been discovered, surprisingly, that a process for the preparation of a solid electrolyte involving the use of a solid electrolyte chosen from sulfides makes it possible to obtain an improved ionic conductivity of said solid electrolyte and a chemical structure which does not degrade.

### ACCOUNT OF THE INVENTION

A subject matter of the invention is thus a process for the preparation of a solid electrolyte comprising the following stages:
a) mixing a solid electrolyte chosen from sulfides with an agent comprising at least sulfur;
b) adding the mixture obtained on conclusion of stage a) to an organic solvent;
c) recovering the solid electrolyte obtained.

Another subject matter of the invention is a process for the preparation of a battery cell comprising the preparation of a solid electrolyte according to the process according to the invention.

Other advantages and characteristics of the invention will become more clearly apparent on examining the detailed description and the appended drawings, in which:

FIG. 1 represents diffractograms of argyrodite involving the implementation of a comparative process:

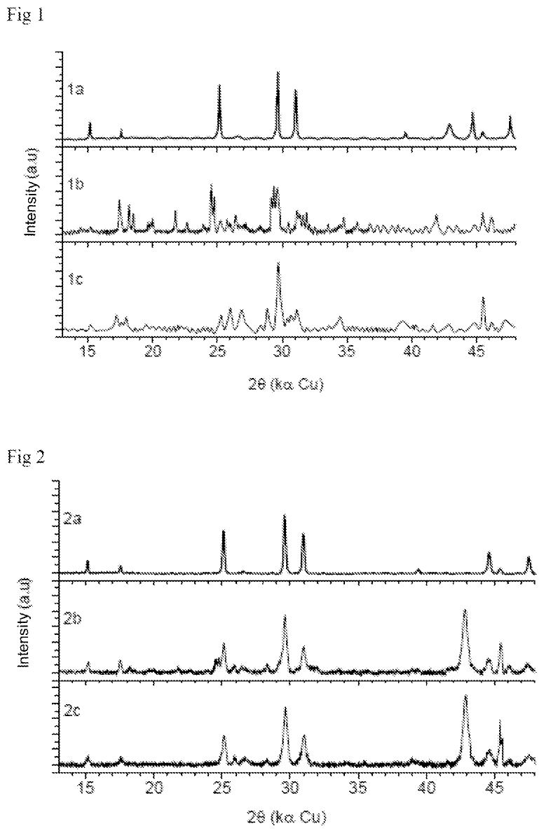

FIG. 2 represents diffractograms of a solid electrolyte involving the implementation of a process according to the invention:

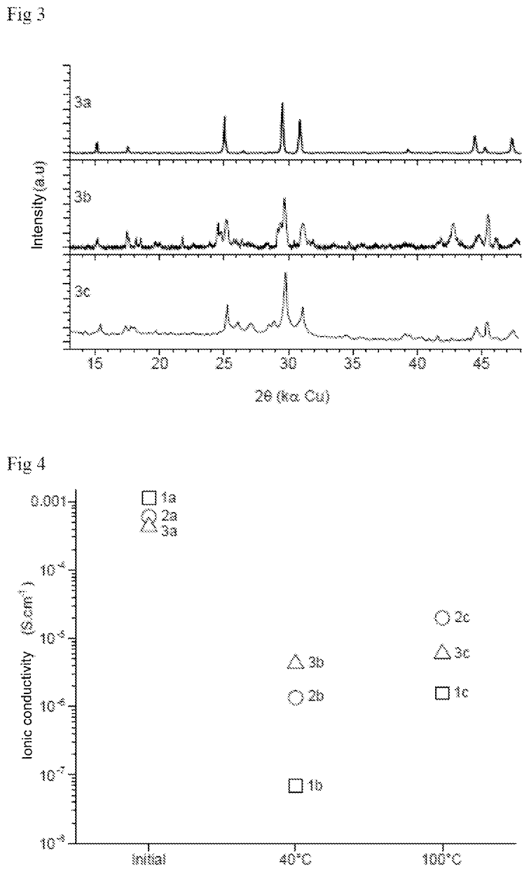

FIG. 3 represents diffractograms of a solid electrolyte involving the implementation of a process according to the invention:

FIG. 4 is a graph showing the ionic conductivity of solid electrolytes obtained on conclusion of various processes.

It is specified that the expression “from . . . to . . . ” used in the present description of the invention should be understood as including each of the limits mentioned.

As indicated above, according to stage a) of the process according to the invention, a solid electrolyte chosen from sulfides is mixed with an agent comprising at least sulfur.

Advantageously, the solid electrolyte chosen from sulfides is chosen from materials of formula:

A^{m+}₁₂₋ₙ₋ₓBⁿ⁺Ch²⁻₆₋ₓXₓ,

in which:
A denotes Cu, Ag or Li, B denotes Ge, Si, Al or P, Ch denotes O, S, Se or Te, preferably Ch denotes S, and X denotes Cl, Br or I;
m is equal to 1;
n is equal to 3, 4 or 5;
x varies from 0 to 2;
   Li_{4-y}Ge_{1-y}P_{y}S_{4-y}, in which y varies from 0 to 1;
   Li_{11-z}M_{2-z}P_{1+z}S₁₂, in which M denotes Ge, Sn or Si and z varies from 0 to 1.75;
   preferably Li₇₋ₜPS₆₋₄X, in which X denotes Cl, Br or I and t varies from 0 to 2, more preferentially Li₆PS₅X, in which X denotes Cl, Br or I, more preferentially still Li₆PS₅Cl.

According to a preferred embodiment, the agent comprising at least sulfur is chosen from P₂S₅, Li₄P₂S₆, S₈, Li₃PS₄, Li₄P₂S₇ and their mixtures, preferably from P₂S₅, Li₄P₂S₇ and their mixture.

Advantageously, the content of agent comprising at least sulfur ranges from 1% to 30% by weight, preferably from 5% to 15% by weight, more preferentially from 8% to 12% by weight, with respect to the total weight of the mixture comprising the solid electrolyte chosen from sulfides and the agent comprising at least sulfur.

As indicated above, according to stage b) of the process according to the invention, the mixture obtained on conclusion of stage a) is added to an organic solvent.

Preferably, the organic solvent is chosen from alcoholic solvents, ethers, such as tetrahydrofuran (THF), aromatic solvents, such as toluene, and nitriles, such as acetonitrile. Preferably, the organic solvent is chosen from alcoholic solvents, more preferentially ethanol.

Preferably, the process according to the invention can additionally comprise a stage d) of drying the solid electrolyte obtained on conclusion of stage c) at a temperature ranging from 40° ° C. to 550° C., preferably from 40° C. to 150° C.

Another subject matter of the invention is a process for the preparation of a battery cell comprising a negative electrode, a positive electrode and a separator comprising the following stages:
preparing a solid electrolyte according to the process according to the invention as described above, forming the separator;
manufacturing said negative electrode and said positive electrode, existing in the form of inks;
coating the negative electrode and positive electrode inks on the separator, the coatings being subsequently dried.

Preferably, the coatings are dried at a temperature ranging from 40° ° C. to 150° C.

The present invention is illustrated in a nonlimiting way by the following examples.

### EXAMPLES

### Example 1: Comparative Process

Argyrodite of formula Li₆PS₅Cl is used.

A diffractogram of the material in the initial state is produced, as represented in FIG. 1 (material 1a). The characteristic peaks of argyrodite can be identified on this diffractogram.

According to a first process, argyrodite is added to ethanol and then dried at 40° C., in order to obtain the material 1b. A diffractogram of the material 1b is then produced, as represented in FIG. 1.

It is clearly apparent that the structure of the argyrodite was destroyed after the dissolution in ethanol. The appearance of several peaks shows that the material breaks down into several phases.

According to a second process, argyrodite is added to ethanol and then dried at 100° C., in order to obtain the material 1c. A diffractogram of the material 1c is then produced, as represented in FIG. 1.

Here again, it is clearly apparent that the structure of the argyrodite was destroyed after the dissolution in ethanol.

Example 1 shows that such a material is not stable in an organic solvent. It thus cannot be used in processes for the coating of electrodes during the preparation of a battery cell, in particular of an all-solid-state battery cell. This is because a process for the coating of an electrode necessarily involves a stage of dissolution in an organic solvent.

### Example 2: Process According to the Invention

Argyrodite of formula Li₆PS₅Cl is used.

It is mixed with the material of formula P₂S₅. More specifically, 10% by weight of the material of formula P₂S₅, with respect to the total weight of the mixture comprising argyrodite of formula Li₆PS₅Cl and the material of formula P₂S₅, are used.

The mixture obtained is then added to ethanol.

A diffractogram of the mixture of the materials is produced, as represented in FIG. 2 (material 2a).

According to a first process, the mixture is added to ethanol and then dried at 40° C., in order to obtain the material 2b. A diffractogram of the material 2b is then produced, as represented in FIG. 2.

It is clearly apparent that the structure of the material characterized is not degraded after the dissolution in ethanol.

According to a second process, the mixture is added to ethanol and then dried at 100° C., in order to obtain the material 2c. A diffractogram of the material 2c is then produced, as represented in FIG. 2.

Here again, it is clearly apparent that the structure of the material characterized is not degraded after the dissolution in ethanol.

Example 2 clearly shows a beneficial effect of the presence of the material of formula P₂S₅ regarding the chemical stability of argyrodite. Argyrodite, by virtue of the presence of the material of formula P₂S₅, is chemically stable in an organic solvent. It can thus be used in processes for the coating of electrodes during the preparation of a battery cell, in particular an all-solid-state battery cell.

### Example 3: Process According to the Invention

Argyrodite of formula Li₆PS₅Cl is used.

It is mixed with the material of formula Li₄P₂S₇. More specifically, 10% by weight of the material of formula Li₄P₂S₇, with respect to the total weight of the mixture comprising argyrodite of formula Li₆PS₅Cl and the material of formula Li₄P₂S₇, are used.

The mixture obtained is then added to ethanol.

A diffractogram of the mixture of the materials is produced, as represented in FIG. 3 (material 3a).

According to a first process, the mixture is added to ethanol and then dried at 40° C., in order to obtain the material 3b. A diffractogram of the material 3b is then produced, as represented in FIG. 3.

It is clearly apparent that the structure of the material characterized is not degraded after the dissolution in ethanol.

According to a second process, the mixture is added to ethanol and then dried at 100° C., in order to obtain the material 3c. A diffractogram of the material 3c is then produced, as represented in FIG. 3.

Here again, it is clearly apparent that the structure of the material characterized is not degraded after the dissolution in ethanol.

Example 3 clearly shows a beneficial effect of the presence of the material of formula Li₄P₂S₇ regarding the chemical stability of argyrodite. Argyrodite, by virtue of the presence of the material of formula Li₄P₂S₇, is chemically stable in an organic solvent. It can thus be used in processes for the coating of electrodes during the preparation of a battery cell, in particular an all-solid-state battery cell.

### Ionic Conductivity

The ionic conductivity at 25° C. was measured for each of the materials 1a to 3c. All of the measurements of the ionic conductivities can be found in FIG. 4.

Thus, a significant drop in the values of the ionic conductivity can be observed for the materials 1b and 1c, compared with the material 1a.

These measurements thus show that this material cannot be used in processes for the coating of electrodes during the preparation of a battery cell, in particular an all-solid-state battery cell, that is to say a process necessarily involving a stage of dissolution in an organic solvent.

This is because the values of the final ionic conductivity of this solid electrolyte in electrode compositions will be very low. Consequently, this will not make it possible to obtain good electrochemical performance qualities of the battery cell and of the battery.

On the other hand, as regards the materials 2a to 2c, even if a drop in the values of the ionic conductivity can be observed for the materials 2b and 2c, compared with that of the material 2a, it is very markedly more moderate.

In any case, the ionic conductivity of the material 2b is much greater than that of the material 1b. Likewise, the ionic conductivity of the material 2c is much greater than that of the material 1c.

This clearly shows a beneficial effect of the presence of the material of formula P₂S₅ on the ionic conductivity of argyrodite.

Similar observations can be made for the materials 3a to 3c.

Even if a drop in the values of the ionic conductivity can be observed for the materials 3b and 3c, compared with that of the material 3a, it is very markedly more moderate.

In any case, the ionic conductivity of the material 3b is much greater than that of the material 1b. Likewise, the ionic conductivity of the material 3c is much greater than that of the material 1c.

This clearly shows a beneficial effect of the presence of the material of formula Li₄P₂S₇ on the ionic conductivity of argyrodite.

1. A method for the preparation of a solid electrolyte, the method comprising:
a) mixing a solid electrolyte chosen from sulfides with an agent comprising at least sulfur;
b) adding the mixture obtained from stage a) to an organic solvent; and
c) recovering the solid electrolyte obtained from stage b).

2. The method of claim 1, wherein the solid electrolyte chosen from sulfides is chosen from the group consisting of materials of formula:
A^{m+}₁₂₋ₙ₋ₓBⁿ⁺Ch²⁻₆₋ₓX⁻ₓ,
wherein:
A denotes Cu, Ag, or Li,
B denotes Ge, Si, Al, or P,
Ch denotes O, S, Se, or Te,
X denotes Cl, Br, or I,
m is equal to 1,
n is equal to 3, 4, or 5, and
x varies from 0 to 2;
Li_{4-y}Ge_{1-y}P_{y}S_{4-y}, wherein y varies from 0 to 1; and
Li_{11-z}M_{2-z}P_{1+z}S₁₂, wherein M denotes Ge, Sn, or Si, and z varies from 0 to 1.75.

3. The method of claim 1, wherein the agent comprising at least sulfur is chosen from the group consisting of P₂S₅, Li₄P₂S₆, S₈, Li₃PS₄, Li₄P₂S₇, and mixtures thereof.

4. The method of claim 1, wherein the content of the agent comprising at least sulfur ranges from 1% to 30% by weight with respect to the total weight of the mixture comprising the solid electrolyte chosen from sulfides and the agent comprising at least sulfur.

5. The method of claim 1, wherein the organic solvent is chosen from the group consisting of alcoholic solvents, ethers, aromatic solvents, and nitriles.

6. The method of claim 1, further comprising:
d) drying the solid electrolyte obtained from stage c) at a temperature ranging from 40° ° C. to 550° C.

7. A method for the preparation of a battery cell comprising a negative electrode, a positive electrode, and a separator, the method comprising:
preparing a solid electrolyte according to the method of claim 1, forming the separator;
manufacturing the negative electrode and the positive electrode, existing in the form of inks; and
coating the negative electrode and positive electrode inks on the separator, the coatings being subsequently dried.
